(19) United States
(12) Patent Application Publication
(10) Pub. No.: US 2014/0358334 A1
(43) Pub. Date: Dec. 4, 2014

(54) AIRCRAFT INSTRUMENT CURSOR CONTROL USING MULTI-TOUCH DEEP SENSORS

(71) Applicant: Gulfstream Aerospace Corporation, Savannah, GA (US)

(72) Inventors: Simón Octavio Colmenares, Savannah, GA (US); Ed Wischmeyer, Savannah, GA (US)

(21) Appl. No.: 13/905,901

(22) Filed: May 30, 2013

(51) Int. Cl. B64D 45/00

(52) U.S. Cl. CPC B64D 45/00
USPC 701/14

(57) ABSTRACT

Aircraft and instrumentation systems are provided. An aircraft includes a display surface, at least one projector, at least one deep sensor, and a controller. The display surface is configured to display images with aircraft information. The at least one projector is oriented to project the images onto the display surface. The at least one deep sensor is configured to generate a signal indicative of a location of an object relative to the display surface. The controller is configured to generate tasks when the signal generated by the at least one deep sensor indicates that the object is touching the display surface. The controller is further configured to generate tasks based on a movement pattern of the object that is indicated by the signal generated by the at least one deep sensor.

### TECHNICAL FIELD

The technical field relates generally to aircraft instrumentation, and more particularly relates to aircraft instrumentation with deep sensors for cursor control on displays.

### BACKGROUND

As modern aviation advances, the demand for ever-increasing flight envelopes and pilot performance grows. To help meet this demand on the aircraft and on the pilots, modern aircraft include impressive arrays of displays, instruments, and sensors designed to provide the pilot with menus, data, and graphical options intended to enhance pilot performance and overall safety of the aircraft and the passengers.

A typical aircraft cockpit includes a cursor control device that employs knobs and buttons to control the displays. The device is often implemented on a column or device shaped like a handle and located on armrests for the pilots. While these cursor control devices in current aircraft are adequate, there is room for improvement. Furthermore, by virtue of current cursor control devices being mounted to specific columns or handlebars, a pilot's personal preference regarding his or her preferred control hand cannot be honored

Another cockpit configuration employs touch sensing displays that have embedded touch sensors. These touch sensing displays are often heavy and expensive. Accordingly, the cost and weight of the aircraft increase when these touch sensing displays are incorporated.

Accordingly, it is desirable to provide an instrumentation system with increased ease of use and decreased cost and weight. Furthermore, other desirable features and characteristics of the present invention will become apparent from the subsequent detailed description of the invention and the appended claims, taken in conjunction with the accompanying drawings and this background of the invention.

### SUMMARY OF EMBODIMENTS

Aircraft and instrumentation systems are provided. An aircraft according to some embodiments includes a display surface, at least one projector, at least one deep sensor, and a controller. The display surface is configured to display images with aircraft information. The at least one projector is oriented to project the images onto the display surface. The at least one deep sensor is configured to generate a signal indicative of a location of an object relative to the display surface. The controller is configured to generate tasks when the signal generated by the at least one deep sensor indicates that the object is touching the display surface. The controller is further configured to generate tasks based on a movement pattern of the object that is indicated by the signal generated by the at least one deep sensor.

An aircraft is provided according to some embodiments. The aircraft includes a display surface, a deep sensor, and a controller. The display surface is configured to display images that include aircraft information. The deep sensor is configured to output a signal indicative of a distance between the display surface and an object. The controller is configured to generate tasks based on the location of the object relative to the display surface.

An instrumentation system for a vehicle is provided according to some embodiments. The instrumentation system includes a display surface, a deep sensor, and a controller. The display surface is configured to display images that include vehicle information. The deep sensor is configured to output a signal indicative of a distance between the display surface and an object. The controller is configured to generate tasks based on the location of the object relative to the display surface.

### BRIEF DESCRIPTION OF THE DRAWINGS

Advantages of the present invention will be readily appreciated, as the same becomes better understood by reference to the following detailed description when considered in connection with the accompanying drawings wherein:

FIG. 1 is a simplified block diagram of an instrumentation system for an aircraft according to some embodiments; and

FIG. 2 is a simplified side view of a cockpit in an aircraft that includes the instrumentation system of FIG. 1 in accordance with some embodiments.

### DETAILED DESCRIPTION

The following detailed description is merely exemplary in nature and is not intended to limit application and uses. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the disclosed embodiments and not to limit the scope of the disclosure which is defined by the claims. Furthermore, there is no intention to be bound by any expressed or implied theory presented in the preceding technical field, background, brief summary, the following detailed description or for any particular computer system.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. Additionally, the following description refers to elements or features being “connected” or “coupled” together. As used herein, “connected” may refer to one element/feature being directly joined to (or directly communicating with) another element/feature, and not necessarily mechanically. Likewise, “coupled” may refer to one element/feature being directly or indirectly joined to (or directly or indirectly communicating with) another element/feature, and not necessarily mechanically. However, it should be understood that, although two elements may be described below, in one embodiment, as being “connected,” in alternative embodiments similar elements may be “coupled,” and vice versa. Thus, although the block diagrams shown herein depict example arrangements of elements, additional intervening elements, devices, features, or components may be present in an actual embodiment.

Finally, for the sake of brevity, conventional techniques and components related to computer systems and other functional aspects of a computer system (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the disclosure.

In some embodiments as disclosed herein, an aircraft includes an instrumentation system with a deep sensing cursor control device. The embodiments permit elimination of knob and button cursor control devices and displays with embedded touch sensors. In general, a combination of front or rear projection images and deep-sensing infrared, ultrasonic, or visual cameras (e.g., gesturing sensors) are utilized. Projectors or pico-projectrors may generate the images on a semi-transparent continuous glass surface that extends across a width of the cockpit. The deep sensing cameras output a signal that indicates when the projection screen has been touched, and a controller acknowledges selections on the projected images.

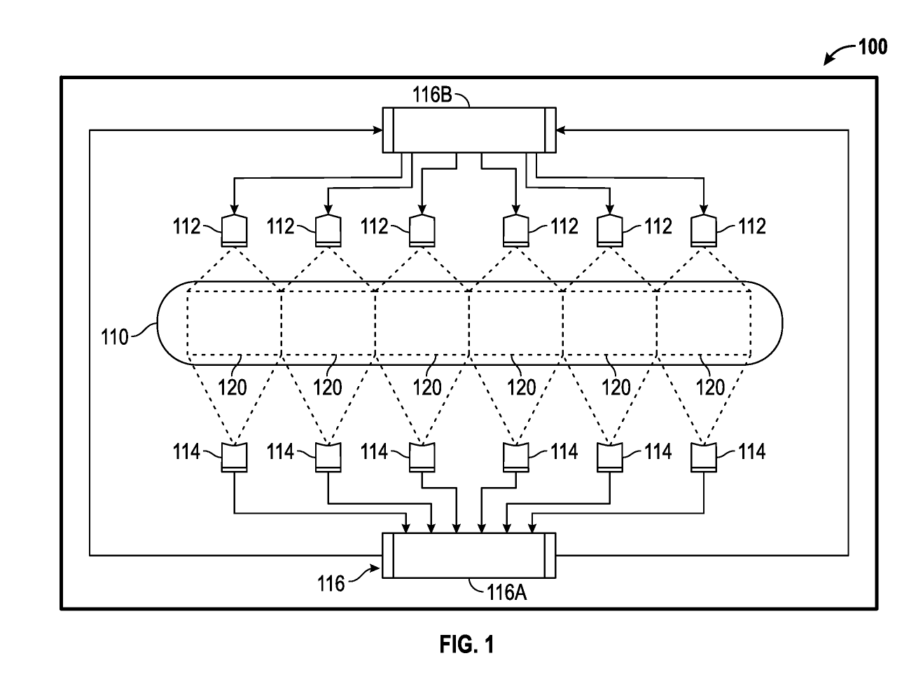

Referring now to FIG. 1, an example of an instrumentation system 100 for an aircraft is illustrated in accordance with some embodiments. The instrumentation system 100 includes a display surface 110, a plurality of projectors 112, a plurality of deep sensors 114, and a controller 116.

The display surface 110 may be any type of display surface, such as a projection screen, an illuminated gauge, an LED readout, or an LCD monitor. In some embodiments, the display surface 110 is a continuous projection glass surface that displays an image projected from the projectors 112. In some embodiments, the display surfaces 110 are optical surfaces that do not include sensing capability. The display surfaces 110 provide a less expensive and lighter weight alternative to conventional touch screen monitors that have embedded touch sensors. Furthermore, lighter weight and less cluttered aircraft cockpits may be designed when compared with designs that incorporate knob and button based center consoles.

The projectors 112 are configured to project images 120 onto the display surface 110. The images 120 may include any suitable aircraft information that relates to operation of the aircraft or other information to be presented to the pilots. For example, the images 120 may include any of the information found on the primary flight display, such as attitude information, flight trajectory, air speed, altitude, and autopilot status. In some embodiments, the images 120 display synthetic vision that represents what the outside terrain would look like if it could be seen.

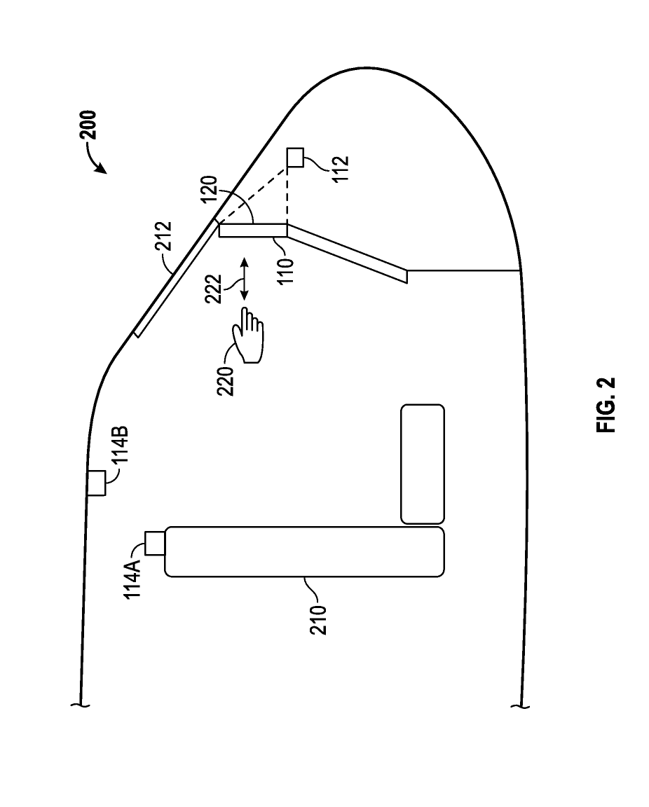

In some embodiments, the projectors 112 are pico projectors disposed behind the display surface 110. For example, when the pilot is looking towards the front of the aircraft, the projectors 112 are rear projection when they are located between the display surface and a front end portion of the aircraft, as illustrated in FIG. 2. Pico projectors utilize light emitting diode or laser light sources, and are sometimes called handheld projectors, pocket projectors, or mobile projectors. It should be appreciated that any suitable technology for projecting the images 120 onto the display surface 110 may be utilized without departing from the scope of the present disclosure. In some embodiments, the projectors 112 are omitted. For example, when the display surface 110 is an LCD monitor, no projectors 112 are needed to display the images 120.

The sensors 114 are multi-touch finger gesturing sensors that are configured to output a signal indicative of the distance between a finger of a pilot (or other object) and the display surface 110 and a relative location between the finger and the display surface 110. The signal further indicates a relative location between the finger or other object and the display surface 110. The sensors 114 are mounted in the cockpit of the aircraft to be at least partially aligned with the movement direction of the finger towards the display surface 110, as illustrated in FIG. 2. In some embodiments, the sensors 114 are mounted and configured to detect an entire area of the display surface 110. The deep sensors 114 may incorporate any suitable technology, such as optical, ultrasound, infrared, and capacitive technologies. The deep sensors may also be known as depth sensors or 3D sensors. In some embodiments, the deep sensors 114 are 3D sensors available from PrimeSense, LTD of Tel-Aviv, Israel.

In some embodiments, the sensors 114 are configured to detect the distance between the display surface 110 and each of several objects. For example, the sensors 114 may be configured to detect when a pointer finger and a middle finger of a pilot each are touching the display surface 110. The relative movement of the two objects may then be tracked and compared to a library of gestures by the controller 116. When the movement of the two objects matches a gesture in the library, the controller 116 is configured to generate a task related to operation of the aircraft. For example, in some embodiments the controller 116 generates a task to enlarge the size of a portion of a displayed image 120 when the display surface 110 is touched with two fingers that then spread apart while touching the display surface 110.

Different gestures may be separately tracked for each of two pilots of the aircraft. For example, one or more sensors 114 may be configured to track movement of objects in front of a portion of the display surface 110 located in front of a first pilot seat, and one or more other sensors 114 may be configured to track movement of objects in front of a portion of the display surface 110 located in front of a second pilot seat. In some embodiments, a single sensor 114 may track movement of objects in front of the display surface 110 located in front of both pilots. It should be appreciated that the number and coverage area of the sensors 114 may be adjusted from those illustrated without departing from the scope of the present disclosure.

The controller 116 receives signals generated by the sensors 114 and generates tasks related to operating the aircraft, as will be described below. The controller may include any combination of software and hardware. For example, the controller may include an application specific integrated circuit (ASIC), an electronic circuit, a processor (shared, dedicated, or group) and memory that execute one or more software or firmware programs, a combinational logic circuit, and/or other suitable components that provide the described functionality. A first sub-controller 116A for receiving signals generated from the deep sensors 114 that indicate a distance between the object and the display surface 110. A second sub-controller 116B generates the images 120 that are projected onto the display surface 110 by the projectors 112. It should be appreciated that the operations of the controller 116 may be broken down into as many or as few sub-controllers as desired without departing from the scope of the present disclosure.

In some embodiments, the generated tasks include altering the projected images 120 and manipulating flight equipment in the aircraft. Examples of altering the projected images 120 include changing image formats, the size of displayed content, the location of displayed content on the display surface 110, and navigating through displayed menus. For example, when the sensor 114 detects an object touching the display surface and moving upwards over a map displayed on a heads-down display, the controller 116 may zoom into the map, out of the map, move the map, expand the size of the map display, or perform other functions related to the map. Other gestures may be incorporated based on the desired manipulation of the images 120. The projected images 120 may therefore be customized and controlled in an intuitive and simple manner.

Manipulating flight equipment may include, for example, lowering or raising landing gear when multiple objects touch the display surface 110 and perform dual or compound gestures at an area associated with a readout of landing gear status. Similarly, the controller 116 may generate a task to activate or de-activate an autopilot system of the aircraft when the pilot touches a portion of the display surface 110 associated with a readout of the autopilot status on the image 120. It should be appreciated that any additional or alternative tasks associated with conventional cursor control devices may be generated by the controller 116 based on the signals generated by the deep sensors 114 without departing from the scope of the present disclosure.

Referring now to FIG. 2, a side view of a cockpit of an aircraft 200 is illustrated in accordance with some embodiments. The aircraft 200 includes a seat 210, a windshield 212, and various components of the instrumentation system 100, where like numbers refer to like components. The seat 210 faces the windshield 212 and the display surface 110.

A first deep sensor 114A is mounted to the seat 210 facing the display surface 110 and a second deep sensor 114B is mounted to the ceiling of the aircraft facing the display surface 110. A hand 220 is illustrated at a distance 222 away from the display surface 110. The sensors 114A, 114B are mounted to be at least partially aligned with a movement direction of the hand 220 towards to the display surface 110. In other words, the hand 220 is at a different depth or distance away from the sensors 114A, 114B as the hand 220 moves toward or away from the display surface 110.

In some embodiments the two deep sensors 114A, 114B provide sensing over separate areas of the display surface 110. In some embodiments the deep sensors 114A, 114B provide sensing over the same areas of the display surface 110 for redundancy. Such sensor redundancy may be incorporated to increase safety, availability, and reliability of the sensing capabilities of the instrumentation system 100.

The embodiments provided herein provide numerous advantages over prior systems. For example, navigation through display menus on displays is improved over current point-and-click, knob and button cursor control devices. The embodiments may utilize rear-projected or front-projected avionics display surfaces that simulate a single glass cockpit. By eliminating the need for embedded touch sensors in displays and knob and button cursor control devices on armrests, costs and weight of the aircraft may be reduced.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

1. An aircraft comprising:
a display surface configured to display images with aircraft information;
at least one projector oriented to project the images onto the display surface;
at least one deep sensor configured to generate a signal indicative of a location of an object relative to the display surface; and
a controller configured to:
generate tasks when the signal generated by the at least one deep sensor indicates that the object is touching the display surface; and
generate tasks based on a movement pattern of the object that is indicated by the signal generated by the at least one deep sensor.

2. The aircraft of claim 1 wherein the controller is further configured to generate tasks that command operation of aircraft flight components based on the signal generated by the at least one deep sensor.

3. The aircraft of claim 1 wherein the controller is further configured to generate tasks that manipulate the images to change at least one of an image format, the size of displayed content, the location of displayed content in the images, and navigational position within menus of the displayed aircraft information.

4. The aircraft of claim 1 wherein the at least one deep sensor is mounted to at least one of a seat in the cockpit and a ceiling of the cockpit.

5. An aircraft comprising:
a display surface configured to display images that include aircraft information;
a deep sensor configured to output a signal indicative of a distance between the display surface and an object; and
a controller configured to generate tasks when the distance indicates a touch of the object on the display surface.

6. The aircraft of claim 5 wherein the controller is further configured to generate tasks that command operation of aircraft flight components based on the signal generated by the at least one deep sensor.

7. The aircraft of claim 5 wherein the controller is further configured to generate tasks that manipulate the images to change at least one of an image format, the size of displayed content, the location of displayed content in the images, and navigation through menus of the displayed aircraft information.

8. The aircraft of claim 5 wherein the deep sensor is mounted to a ceiling of a cockpit of the aircraft.

9. The aircraft of claim 5 wherein the deep sensor is mounted to a seat in a cockpit of the aircraft.

10. The aircraft of claim 5 wherein the controller is further configured to generate tasks based on a gesturing pattern of the object.

11. The aircraft of claim 5 further comprising a projector configured to project images onto the display surface.

12. The aircraft of claim 5 further comprising a plurality of rear projection pico projectors configured to project the displayed aircraft information onto the display surface.

13. An instrumentation system for a vehicle, the system comprising:
a display surface configured to display images that include vehicle information;
a deep sensor configured to output a signal indicative of a distance between the display surface and an object; and
a controller configured to:
generate tasks based a location of the object relative to the display surface.

14. The instrumentation system of claim 13 wherein the controller is further configured to generate tasks that command operation of vehicle components based on the signal generated by the at least one deep sensor.

15. The instrumentation system of claim 13 wherein the controller is further configured to generate tasks that manipulate the images to change at least one of an image format, the size of displayed content, the location of displayed content in the images, and navigation through menus of the displayed vehicle information.

16. The instrumentation system of claim 13 wherein the deep sensor is configured to be mounted to a ceiling of a cockpit of the vehicle.

17. The instrumentation system of claim 13 wherein the deep sensor is configured to be mounted to a seat in the vehicle.

18. The instrumentation system of claim 13 wherein the controller is further configured to generate tasks based on a movement pattern of the object indicated by the signal generated by the deep sensor.

19. The instrumentation system of claim 13 further comprising a projector configured to project images onto the display surface.

20. The instrumentation system of claim 13 further comprising a plurality of rear projection pico projectors configured to project the displayed vehicle information onto the display surface.
